(19) United States
(12) Patent Application Publication
(10) Pub. No.: US 2006/0043077 A1
(43) Pub. Date: Mar. 2, 2006

(54) CO2 laser machining head with integrated monitoring device

(75) Inventors: Michael Nittner, Camburg (DE); Frank Seidel, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: JENOPTIK Automatisierungstechnik GmbH

(21) Appl. No.: 11/212,012

(22) Filed: Aug. 24, 2005

(30) Foreign Application Priority Data
Aug. 25, 2004 (DE) 10 2004 041 682.6

(51) Int. Cl. B23K 26/06; B23K 26/38

(52) U.S. Cl. 219/121.75; 219/121.83

(57) ABSTRACT

A CO₂ laser machining head with machining optics comprising at least one lens, through which a CO₂ laser beam is directed to a workpiece, and a monitoring device for monitoring defects and contamination in the machining optics, comprising a plurality of light emitting diodes and photodiodes which are directed to an optically active surface of the machining optics so as to be distributed around the CO₂ laser bean in order to determine defects and contamination of the optically active surfaces of the machining optics by detecting reflected components and stray components of the radiation of the light emitting diodes.

### CROSS-REFERENCE TO RELATED APPLICATIONS

This application claims priority of German Application No. 10 2004 041 682.6, filed Aug. 25, 2004, the complete disclosure of which is hereby incorporated by reference.

### BACKGROUND OF THE INVENTION

a) Field of the Invention

The invention is directed to a laser machining head with machining optics through which a CO₂ laser beam is directed to a workpiece to be machined.

b) Description of the Related Art

In order to monitor contamination and defects in the machining optics, which generally comprise a lens or a lens followed by a protective glass in the beam direction, a monitoring unit is integrated in the laser machining head. Solutions of this kind are known from the prior art of which DE 198 39 930 C1 was determined as the solution coming closest to the invention.

DE OS 38 07 873 A1 discloses a laser machining head of the type mentioned above in which a sensor that is sensitive to infrared radiation is arranged and detects the heat radiated by a lens. Defects in the lens lead to an excessive increase in the temperature of the lens in the area of the defect and therefore to an increase in the radiated heat. When the detected heat radiation exceeds a given threshold, the laser beam is switched off to prevent destruction of the lens by local overheating.

The CO₂ laser device disclosed in DE 202 06 255 U1 also has a device for generating a signal for switching off the laser. A problem is posed by reduced transmission of a lens or of a protective glass caused by accumulations of small material traces of the workpiece to be machined or by occurring burn residues. As transmission decreases, the absorption and, therefore, the heating increases and can lead to destruction of the lens. In order to detect heat radiation, at least one temperature sensor is arranged in the vicinity of the outer circumference of the lens. This temperature sensor has a low signal rise time constant for generating a switch-off signal for the laser. It is advantageous when one or more temperature measuring devices receive the housing temperature of the at least one temperature sensor as a reference value so that the environmental influence or ambient temperature of the temperature sensor can be compensated.

In DE 195 07 401 A1, an individual machining optics component, preferably that closest to the workpiece, e.g., a protective glass which is intended to protect the focusing optics from contamination, is monitored by detecting the stray radiation from this component. Assuming that the value of the stray radiation is fundamentally constant with the laser output remaining unchanged, it can be concluded from a positive or negative deviation of the measured stray radiation that there is a disturbance in the radiation transmission from the laser source to the workpiece. Such disturbances are brought about essentially by defects occurring as a result of thermal loading due to the effect of the laser radiation on the component parts of the machining optics and due to the contamination of the surface of the machining optics closest to the workpiece. When the detected measurement value exceeds or falls below a given reference value, a signal is emitted and the laser is switched off.

To monitor the contamination of the machining optics on the workpiece side in particular, the monitoring device is designed in such a way that the detector or the free end of a glass fiber, whose other end is connected to the detector, is arranged at a plane surface of the component part on the workpiece side. In order to monitor other component parts of the machining optics, e.g., an inner lens, a detector can also be arranged at the latter.

The arrangement described in DE 196 05 018 A1 monitors the proportion of a component of the laser beam coupled transversely into the protective glass to be monitored. As the contamination of the protective glass increases, this component is increasingly scattered at the contaminated workpiece-side surface and is detected by a radiation sensor arranged at the front side.

Although the above-cited reference indicates that both online and offline monitoring is possible with this solution, there is no indication of how offline monitoring should function when the machining laser is not turned on. A comparable solution is disclosed in WO98/33059.

DE 101 13 518 A1 offers an improvement over these last two solutions in that it does not have the disadvantage that the stray radiation is measured along the edge of the protective glass.

DE 101 13 518 A1 discloses a laser machining head with a lens arrangement and a protective glass in which a radiation detector arrangement oriented to a protective glass is provided in front of or behind the protective glass in the beam direction outside the beam path of the laser beam. The radiation detector arrangement can also be arranged in front of the lens arrangement in the beam direction so as to detect all stray radiation coming from the protective glass and the lens arrangement.

The radiation detector arrangement necessarily comprises a stray radiation detector, which is advantageously inserted into the housing of the laser machining head, and advantageously comprises a detector for measuring the intensity of the laser beam to which a coupled out component of the laser beam is deflected. In this way, a reference stray radiation value can be obtained in a simple manner. Without detection of a reference stray radiation value, however, monitoring of this kind may only function when the laser output during the operation is always the same and is held constant.

All of the solutions mentioned above use the machining laser beam or the heat radiation caused by the machining laser beam for monitoring and are therefore only suitable for monitoring during online operation of the laser machining head.

In the solutions in which beam components of the machining laser beam are detected, the measurement signals are not only influenced by changes in the component parts to be monitored, but also by changes in laser output so that the actual laser output must be monitored in addition or, for variably adjustable laser outputs that must be kept constant during a machining process, different reference values must be determined and the measured values must be compared to them in order to trigger actions when these values are exceeded.

DE 198 39 930 C1 describes a device for monitoring a protective element of laser optics in which at least one light source, in addition to the machining laser radiation source, and at least one light detector are coupled to the lateral surface of the protective element to be monitored. Filters which are transparent for the wavelength of the machining laser and the wavelength of the light source, but not for the ambient light, are advantageously arranged in front of the light detectors. In addition, one or more temperature sensors are advantageously provided, some of which respond quickly and some slowly to changes in temperature. In an advantageous manner, light emitting diodes are used as light sources and photodiodes are used as light detectors. If the latter cannot be arranged directly at the lateral surface of the protective elements due to lack of space, they can be coupled by means of light guides.

Although it is not expressly mentioned, this solution can be used for online and offline monitoring. It is disadvantageous that only one optical element can be monitored and the protective element must be removed in order to change defective light emitting diodes or photodiodes.

### OBJECT AND SUMMARY OF THE INVENTION

It is the primary object of the present invention to provide a laser machining head with an integrated monitoring device in which machining optics which can also comprise a plurality of component parts can be monitored and tested online and offline. Further, the detectors and transmitters of the monitoring device are easily accessible for purposes of replacement.

This object is met for a laser machining head wherein the machining head is a CO₂ laser machining optics further comprising at least one lens through which a CO₂ laser beam is directed to a workpiece and a monitoring device for monitoring defects and contamination in the machining optics and further comprising light emitting diodes and photodiodes. The light emitting diodes and photodiodes are directed to an optically active surface of the machining optics so as to be distributed around the CO₂ laser beam in order to determine defects and contamination of the optically active surfaces of the machining optics by detecting reflected components and stray components of the radiation of the light emitting diodes.

The invention will be described more fully in the following with reference to embodiment examples.

### BRIEF DESCRIPTION OF THE DRAWINGS

In the drawings:

FIG. 1a shows a schematic diagram of a first embodiment example of a laser machining head according to the invention; and

FIG. 1b shows the arrangement of the light emitting diodes and photodiodes according to the first embodiment example.

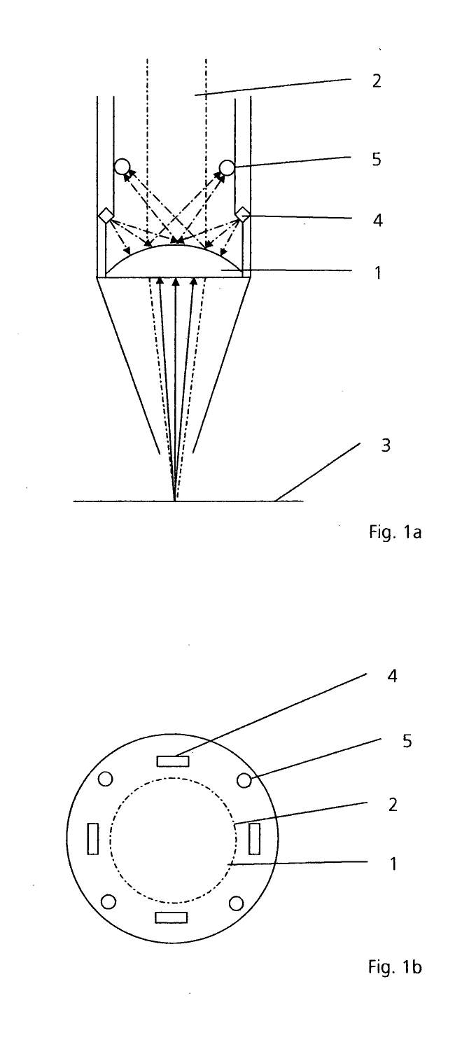

As essential features, the laser machining head shown in FIG. 1 a comprises machining optics, in this case, a lens 1 through which a CO₂ laser beam 2 is directed to the workpiece 3. A monitoring device is provided for monitoring the optically active surfaces of the lens 1. The monitoring device comprises a plurality of transmitters, in this case, light emitting diodes 4, and a plurality of detectors, in this case, photodiodes 5, and evaluating and control electronics, not shown, which are connected on the input side to the photodiodes 5 and on the output side to a laser control, not shown, and a signal transmitter, not shown.

The light emitting diodes 4 and the photodiodes 5 are arranged, respectively, on the side of the lens 1 remote of the workpiece 3 (see FIG. 1b) so as to be uniformly distributed in a plane outside the beam path of the CO₂ laser beam 2. The plane in which the photodiodes 5 are arranged is advantageously at a greater distance from the lens 1 than the plane in which the light emitting diodes 4 are arranged. This prevents the radiation from the light emitting diodes 4 from impinging directly on the photodiodes 5. The more light emitting diodes 4 and photodiodes 5 used, the better the illumination of a convex lens surface and the better the reception of the light reflected and scattered by the latter. In the present embodiment example, four light emitting diodes 4 and four photodiodes 5 are used. In order to prevent the light emitting diodes 4 from casting a shadow on the detection area of the photodiodes 5, the diodes are arranged alternately adjacent to one another on a circle or, as is shown in FIG. 1b, are placed respectively on circles of different diameters.

The photodiodes 5 to be used do not respond sensitively to the wavelength of the CO₂ laser beam 2, so that their measurement signal is not influenced by reflected or stray radiation components of the CO₂ laser beam 2.

A layer which is not transparent to the CO₂ laser beam 2 is advantageously applied to the workpiece-side surface of the lens 1 so that the light phenomena occurring during the machining of the workpiece do not influence the measurements.

The measurement results do not depend upon fluctuations in the output or deliberate changes in the output of the CO₂ laser beam 2 because the measured stray radiation and reflected radiation are caused by an additional radiation and not by the CO₂ laser beam 2. Reference values that are stored once can be used as threshold values through the use of light emitting diodes 4 with permanently constant luminosity.

In contrast to DE 198 39 930 C1, monitoring according to the invention can detect not only reflected or stray radiation from the light emitting diodes at the adjacent surfaces of an optical component part, but also that of other optically active surfaces in the beam direction.

Accordingly, when the machining optics comprise a plurality of component parts—in practice, this could be a lens 1 and a protective glass—both component parts are actually monitored. The increase in the reflected radiation and stray radiation impinging on the photodiodes 5 due to defects or interfering contamination is so great that a noticeable increase in the measurement signal is detected even when these phenomena occur at the outer surface of the protective glass, which is the fourth optically active surface considered from the photodiodes 5.

A plurality of reference signals are advantageously stored as threshold values in the evaluating and control electronics, e.g., in order to initiate various actions such as warning signals or to switch off the laser when these threshold values are exceeded. It is also advantageous when the evaluating and control electronics are designed in such a way that a continuous rise in the measurement signals can be distinguished from an abrupt rise in the measurement signals so that defects that occur abruptly or that have an increasing contamination can be detected based on this criterion independent from the signal level.

Photodiodes 5 that detect different wavelength ranges can also be used in order to distinguish between different causes that respond differently in reflection behavior and scattering behavior to different wavelengths.

Temperature sensors can advantageously be provided in addition to the photodiodes 5 in order to have a second measuring method for online operation. By comparing the measurement results to one another, it can be determined whether or not changes in measurement values are caused by defective measuring apparatus.

The light emitting diodes 4 and photodiodes 5 can also be arranged so as to be oriented to the machining optics on the workpiece side; however, this is not advantageous due to the risk of contamination of the light emitting diodes 4 and photodiodes 5.

Instead of a CO₂ laser, other types of laser can also be used in combination with photodiodes 5 whose detection range does not include the emission wavelength of the laser. In principle, phototransistors can also be used instead of photodiodes 5.

The person skilled in the field of the invention will appreciate that the invention is not limited to the details of the embodiment forms described herein by way of example and that the present invention can be embodied in other special forms without departing from the scope of the invention as set forth in the accompanying claims.

What is claimed is:

1. A CO₂ laser machining head comprising:
machining optics further comprising at least one lens through which a CO₂ laser beam is directed to a workpiece; and
a monitoring device for monitoring defects and contamination in the machining optics and further comprising light emitting diodes and photodiodes;
said light emitting diodes and photodiodes being directed to an optically active surface of the machining optics so as to be distributed around the CO₂ laser bean in order to determine defects and contamination of the optically active surfaces of the machining optics by detecting reflected components and stray components of the radiation of the light emitting diodes.

2. The CO₂ laser machining head according to claim 1, wherein the light emitting diodes and photodiodes are directed to an optically active surface adjoining the machining optics in order to detect reflected radiation and stray radiation from all of the optically active surfaces following in the beam direction.

3. The CO₂ laser machining head according to claim 1, wherein temperature sensors are provided in addition to the photodiodes in order to detect influence on the measured value by the measuring means through a second measuring method.

4. The CO₂ laser machining head according to claim 1, wherein a reflective layer is applied to an optically active surface in order to prevent light from penetrating the machining optics on the workpiece side.

5. The CO₂ laser machining head according to claim 1, wherein the light emitting diodes and the photodiodes are arranged, respectively, so as to be uniformly distributed on a circle and the photodiodes are arranged at a greater distance from the machining optics than the light emitting diodes so as to safely prevent the radiation from the light emitting diodes from impinging directly on the photodiodes.
